(19) United States
(12) Patent Application Publication
(10) Pub. No.: US 2024/0291192 A1
(43) Pub. Date: Aug. 29, 2024

(54) Connector Terminal and Connector

(71) Applicants: SIBAS Electronics (Xiamen) Co. Ltd., Xiamen City (CN); Tyco Electronics (Shanghai) Co., Ltd., Shanghai (CN)

(72) Inventors: Qiang Yuan, Xiamen (CN); Liqiang (Gino) Yao, Shanghai (CN); Yong (Chris) Wang, Shanghai (CN); Lei Wang, Xiamen (CN); Renzhong (Andy) Lin, Xiamen (CN)

(73) Assignees: SIBAS Electronics (Xiamen) Co. Ltd., Xiamen City (CN); Tyco Electronics (Shanghai) Co., Ltd., Shanghai (CN)

(21) Appl. No.: 18/584,404

(22) Filed: Feb. 22, 2024

(30) Foreign Application Priority Data
Feb. 24, 2023 (CN) 202320306859.X

(51) Int. Cl. H01R 13/428; H01R 4/18

(52) U.S. Cl. CPC H01R 13/428; H01R 4/184

(57) ABSTRACT

A connector terminal includes a terminal body having a hollow cylindrical part and a terminal sheath that is sheathed on the hollow cylindrical part of the terminal body. The terminal sheath has an elastic locking piece formed on a circumferential wall. The elastic locking piece tilts outward and is configured to engage with a connector housing to lock the connector terminal in the connector housing.

### CROSS-REFERENCE TO RELATED APPLICATION

This application claims the benefit of the filing date under 35 U.S.C. § 119(a)-(d) of Chinese Patent Application No. 202320306859.X, filed on Feb. 24, 2023.

### FIELD OF THE INVENTION

The present invention relates to a connector terminal and a connector comprising the connector terminal.

### BACKGROUND

A heavy-duty connector typically includes a housing, a terminal, and an elastic locking piece. The terminal is inserted into the housing. In the prior art, a radial flange is formed on the circumferential wall of the terminal body by stamping. The elastic locking piece is fixed in the housing and pressed against the radial flange of the terminal to lock the terminal in the housing, thereby effectively preventing the terminal from being pulled out of the housing.

However, in the prior art, due to the need to punch a circle of radial flange on the circumferential wall of the terminal body, the wall thickness of the radial flange of the terminal is relatively thin, seriously affecting the conductivity of the terminal. Moreover, when stamping a circle of radial flange, it is easy to tear the circumferential wall of the terminal body, which increases the difficulty of terminal manufacturing.

In addition, in the prior art, in order to provide auxiliary contact force to the elastic cantilever on the terminal, a spring coil needs to be installed on the terminal. Therefore, in the prior art, it is necessary to provide a separate elastic locking piece and a spring coil. This leads to complex structures of connector terminals and connectors, low manufacturing efficiency, and high costs.

### SUMMARY

A connector terminal includes a terminal body having a hollow cylindrical part and a terminal sheath that is sheathed on the hollow cylindrical part of the terminal body. The terminal sheath has an elastic locking piece formed on a circumferential wall. The elastic locking piece tilts outward and is configured to engage with a connector housing to lock the connector terminal in the connector housing.

### BRIEF DESCRIPTION OF THE DRAWINGS

Features of the present invention will become more apparent by describing in detail exemplary embodiments thereof with reference to the accompanying drawings, in which:

FIG. 1 is a perspective view of a connector terminal according to an embodiment;

FIG. 2 is an exploded perspective view of the connector terminal;

FIG. 3 is a sectional exploded perspective view of the connector terminal;

FIG. 4 is a perspective view of a terminal body of the connector terminal; and

FIG. 5 is a perspective view of a terminal sheath of the connector terminal.

### DETAILED DESCRIPTION OF EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

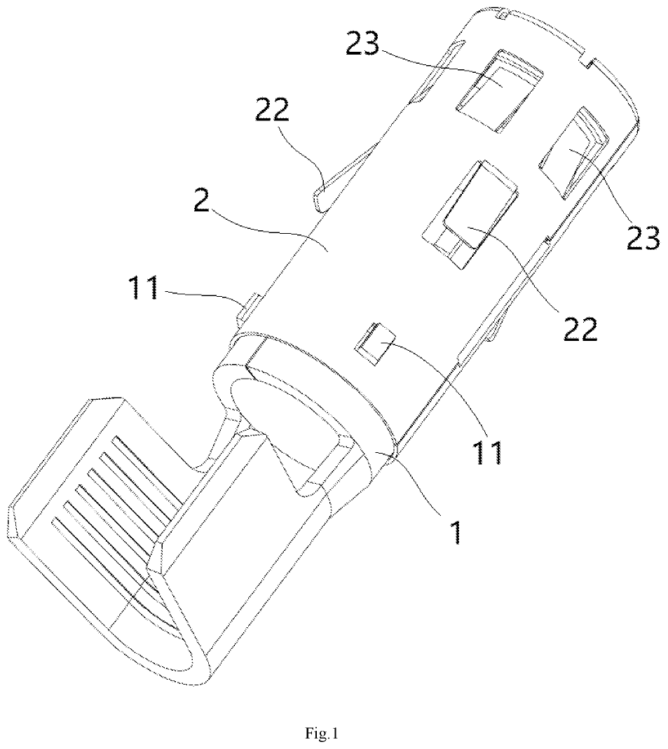

As shown in FIGS. 1 to 3, in an exemplary embodiment of the present invention, a connector terminal is disclosed. The connector terminal includes a terminal body 1 and a terminal sheath 2. The terminal body 1 has a hollow cylindrical part 10. The terminal sheath 2 is installed on the cylindrical part 10 of the terminal body 1. An elastic locking piece 22 is formed on a circumferential wall of the terminal sheath 2, which tilts outward and is used to engage with a connector housing to lock the connector terminal in the connector housing.

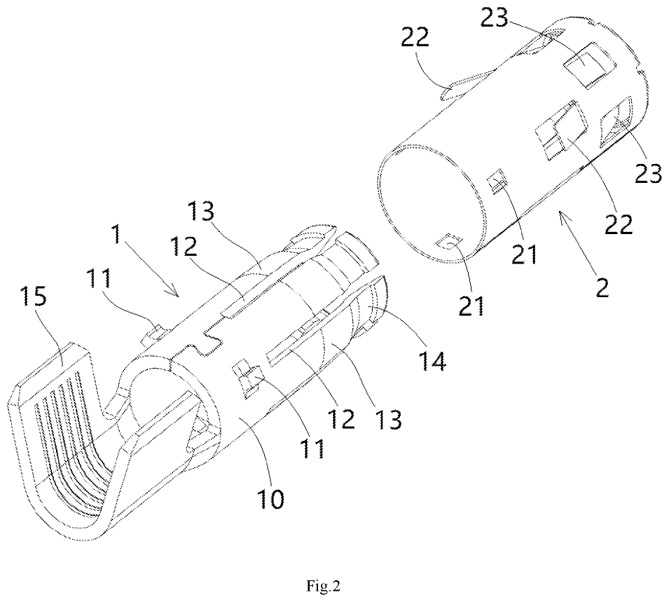

As shown in FIGS. 1 and 2, in the illustrated embodiments, a plurality of elastic locking pieces 22 are formed on the circumferential wall of terminal sheath 2. The elastic locking pieces 22 are spaced from each other in the circumferential direction of terminal sheath 2.

As shown in FIGS. 1 to 4, in the illustrated embodiments, multiple protrusions 11 are formed on the circumferential wall of the cylindrical part 10 of the terminal body 1. The protrusions 11 are spaced from each other in the circumferential direction of the cylindrical part 10. A plurality of connection holes 21 are formed in the circumferential wall of the terminal sheath 2, and the multiple protrusions 11 are respectively connected to the multiple connection holes 21 to fix the terminal sheath 2 on the cylindrical part 10.

The cylindrical part 10 has a front end and a rear end opposite in its axial direction. The front end of the cylindrical part 10 is used for electrical contact with a mating terminal of an inserted mating connector.

As shown in FIG. 2, in the illustrated embodiment, the terminal body 1 also includes a crimping part 15. The crimping part 15 is connected to the rear end of the cylindrical part 10 and is adapted to be crimped onto a cable for electrical connection with the cable.

As shown in FIGS. 1 to 3 and 5, in the illustrated embodiments, the elastic locking piece 22 is located on the circumferential wall between the front and rear ends of the terminal sheath 2 and extends obliquely towards the outside and rear end of the terminal sheath 2.

In the illustrated embodiments, the protrusion 11 and the connection hole 21 are formed on the circumferential walls of the rear ends of the cylindrical part 10 and the terminal sheath 2, respectively.

As shown in FIGS. 2 to 4, in the illustrated embodiments, a plurality of axial grooves 12 are formed in the circumferential wall of the cylindrical part 10. The multiple axial grooves 12 are spaced from each other in the circumferential direction of the cylindrical part 10 and extend axially to the front end face of the cylindrical part 10 to divide the circumferential wall of the cylindrical part 10 into multiple elastic cantilevers 13. Multiple elastic cantilevers 13 are used for electrical contact with the mating terminal inserted from an opening at the front end of the cylindrical part 10.

As shown in FIGS. 2, 3, and 5, in the illustrated embodiments, a plurality of auxiliary elastic cantilevers 23 are formed on the circumferential wall of the front end of the terminal sheath 2. The auxiliary elastic cantilevers 23 are spaced from each other in the circumferential direction of the terminal sheath 2. The multiple auxiliary elastic cantilevers 23 of the terminal sheath 2 rest against the multiple elastic cantilevers 13 of the cylindrical part 10, respectively, to provide auxiliary contact force to the multiple elastic cantilevers 13. In this way, the electrical contact force between the elastic cantilever 13 and the mating terminal can be increased to ensure reliable electrical contact between the elastic cantilever 13 and the mating terminal. In the illustrated embodiment, multiple auxiliary elastic cantilevers 23 extend obliquely towards the interior and front end of terminal sheath 2.

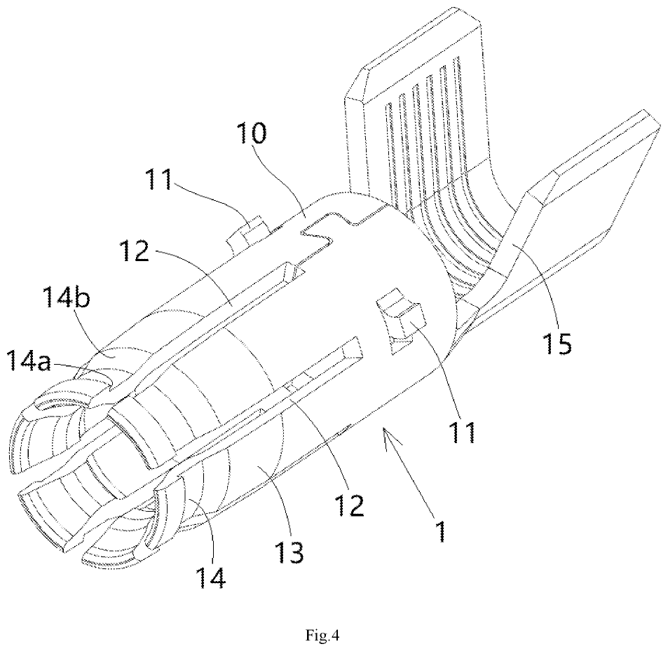

As shown in FIGS. 2 to 4, in the illustrated embodiments, a groove 14 is formed on the outer surface of the free end of multiple elastic cantilevers 13, and the groove 14 has a first side 14a and a second side 14b opposite to the first side 14a. The first side 14a extends along the radial direction of the cylindrical part 10, while the second side 14b extends obliquely relative to the radial direction of the cylindrical part 10, as shown in FIG. 4. The first side 14a rests against the free end of the auxiliary elastic cantilever 23 to position the auxiliary elastic cantilever 23. In the illustrated embodiment, the depth of the groove 14 is shallow, and the second side 14b extends obliquely relative to the radial direction of the cylindrical part 10, so it will not have a significant impact on the conductivity of the elastic cantilever 13.

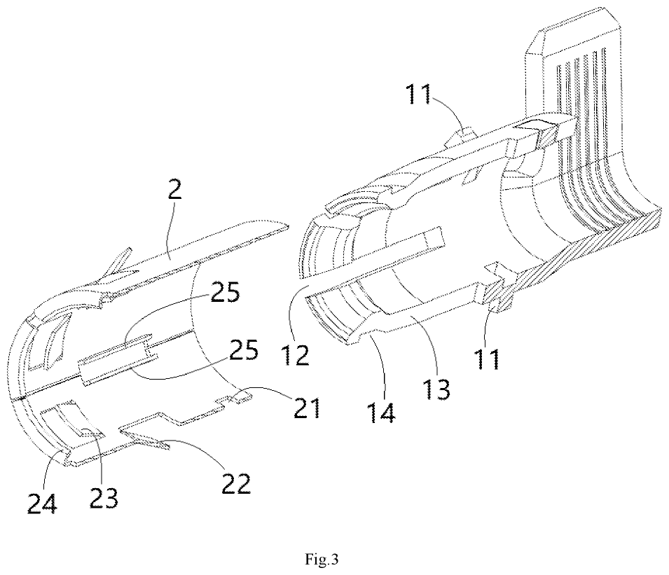

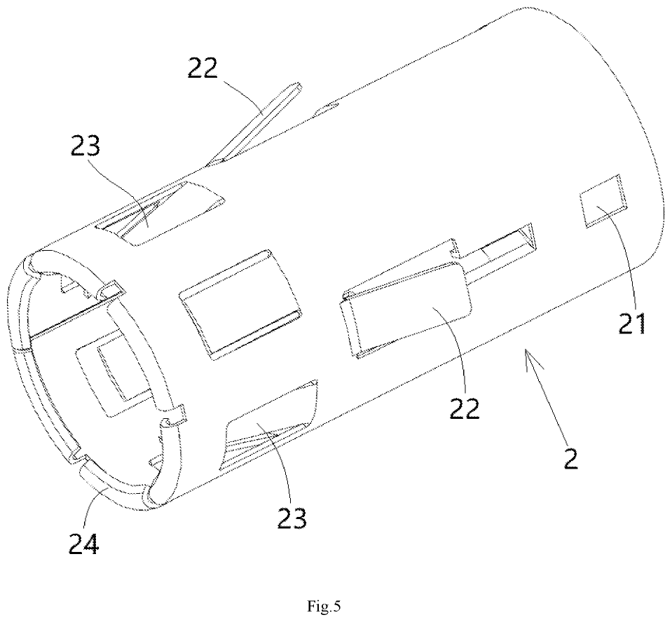

In the embodiment shown in FIGS. 3 and 5, an oblique flanging part 24 rolled inward is formed at the front end of the terminal sheath 2. The oblique flanging part 24 is used to guide the mating terminal to be inserted into the front end of the cylindrical part 10 of the terminal body 1.

As shown in FIG. 3, in the illustrated embodiments, a positioning rib 25 is formed on the inner side of the circumferential wall of the terminal sheath 2, and the positioning rib 25 extends along the axial direction of the terminal sheath 2. The positioning rib 25 on the terminal sheath 2 is mated with the axial groove 12 on the cylindrical part 10 to position the terminal sheath 2 in the circumferential direction.

In the illustrated embodiments, each of the terminal body 1 and the terminal sheath 2 is an integral stamped part. This can improve manufacturing efficiency and reduce production costs.

In another exemplary embodiment, a connector is also disclosed. The connector includes a housing and the above connector terminal installed in the housing. The elastic locking piece 22 of the connector terminal is engaged with the housing to lock the connector terminal in the housing.

In the aforementioned exemplary embodiments of the present invention, due to the formation of an elastic locking piece 22 on the terminal sheath 2 for locking the terminal in the connector housing, there is no need to provide an elastic locking piece 22 separately, which reduces the number of components of the connector, reduces the manufacturing cost of the connector, and improves the assembly efficiency of the connector. In addition, in the aforementioned exemplary embodiments according to the present invention, since the elastic locking piece 22 is integrated on the terminal sheath 2, there is no need to form a circle of radial flange on the circumferential wall of the terminal body 1 to support the elastic locking piece 22, which reduces the manufacturing difficulty of the terminal, and the terminal sheath 2 can improve the conductivity of the connector terminal. In addition, in some exemplary embodiments according to the present invention, the terminal sheath 2 is also integrated with an auxiliary clastic cantilever 23, so there is no need to install a spring coil on the elastic cantilever of the terminal body 1, which further reduces the number of components of the connector and improves the assembly efficiency of the connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector terminal, comprising:
a terminal body having a hollow cylindrical part; and
a terminal sheath that is sheathed on the hollow cylindrical part of the terminal body, the terminal sheath has an elastic locking piece formed on a circumferential wall, the elastic locking piece tilts outward and is configured to engage with a connector housing to lock the connector terminal in the connector housing.

2. The connector terminal of claim 1, wherein the elastic locking piece is one of a plurality of elastic locking pieces formed on the circumferential wall.

3. The connector terminal of claim 2, wherein the elastic locking pieces are spaced from each other in a circumferential direction of the terminal sheath.

4. The connector terminal of claim 1, wherein a wall of the hollow cylindrical part has a plurality of protrusions spaced from each other in a circumferential direction of the hollow cylindrical part.

5. The connector terminal of claim 4, wherein a plurality of connection holes are formed in the circumferential wall of the terminal sheath, the protrusions are each connected to one of the connection holes to fix the terminal sheath on the hollow cylindrical part.

6. The connector terminal of claim 5, wherein the hollow cylindrical part has a front end and a rear end opposite the front end in an axial direction, the front end of the hollow cylindrical part is electrically connectable with an inserted mating terminal.

7. The connector terminal of claim 6, wherein the terminal body has a crimping part connected to the rear end of the hollow cylindrical part, the crimping part is crimpable onto a cable for electrical connection with the cable.

8. The connector terminal of claim 6, wherein the elastic locking piece is on the circumferential wall between a front end and a rear end of the terminal sheath, the elastic locking piece extends obliquely toward an outside and the rear end of the terminal sheath.

9. The connector terminal of claim 8, wherein the protrusions are formed on the rear end of the hollow cylindrical part and the connection holes are formed on the rear end of the terminal sheath.

10. The connector terminal of claim 9, wherein a plurality of axial grooves are formed in the wall of the hollow cylindrical part, the axial grooves are spaced apart from each other in the circumferential direction of the hollow cylindrical part and extend to a front end face of the hollow cylindrical part.

11. The connector terminal of claim 10, wherein the axial grooves divide the wall of the hollow cylindrical part into a plurality of elastic cantilevers that electrically contact the inserted mating terminal.

12. The connector terminal of claim 11, wherein a plurality of auxiliary elastic cantilevers are formed on the circumferential wall at the front end of the terminal sheath, the auxiliary elastic cantilevers are spaced from each other in a circumferential direction of the terminal sheath.

13. The connector terminal of claim 12, wherein the auxiliary elastic cantilevers abut against the elastic cantilevers and provide an auxiliary contact force to the elastic cantilevers.

14. The connector terminal of claim 13, wherein the auxiliary elastic cantilevers extend diagonally toward an interior and the front end of the terminal sheath.

15. The connector terminal of claim 14, wherein a groove is formed on an outer surface of a free end of the elastic cantilevers.

16. The connector terminal of claim 15, wherein the groove has a first side and a second side opposite to the first side, the first side extends along a radial direction of the hollow cylindrical part and the second side extends obliquely relative to the radial direction of the hollow cylindrical part, the first side rests against a free end of the auxiliary elastic cantilevers.

17. The connector terminal of claim 8, wherein an oblique flanging part rolled inward is formed at the front end of the terminal sheath, the oblique flanging part guides the inserted mating terminal.

18. The connector terminal of claim 10, wherein a positioning rib is formed on an inner side of the circumferential wall of the terminal sheath, the positioning rib extends along an axial direction of the terminal sheath, the positioning rib mates with one of the axial grooves on the hollow cylindrical part to position the terminal sheath in the circumferential direction.

19. The connector terminal of claim 1, wherein each of the terminal body and the terminal sheath is an integral stamped part.

20. A connector, comprising:
a housing; and
a connector terminal installed in the housing, the connector terminal includes a terminal body having a hollow cylindrical part and a terminal sheath that is sheathed on the hollow cylindrical part of the terminal body, the terminal sheath has an elastic locking piece formed on a circumferential wall, the elastic locking piece tilts outward and engages with the housing to lock the connector terminal in the housing.
